(19) United States
(12) Patent Application Publication
(10) Pub. No.: US 2005/0212313 A1
(43) Pub. Date: Sep. 29, 2005

(54) Apparatus for picking up and bagging animal excrement

(76) Inventor: Thomas K. Hong, Toronto (CA)

Correspondence Address: THOMAS K. HONG, 1666 QUEEN STREET EAST, UNIT 18, TORONTO, M4L 1G3, CA

(21) Appl. No.: 10/810,590

(22) Filed: Mar. 29, 2004

(51) Int. Cl. A01K 29/00; E01H 1/12

(52) U.S. Cl. 294/1.3

(57) ABSTRACT

An apparatus for picking up and bagging animal excrement comprises upper and a lower jaw members each having a hand-grip end and a scooping end and a connecting hinge at their hand-grip ends. In an open position, the scooping ends of the upper and lower jaw members are separated one from the other to permit animal excrement to pass therethrough. In a closed position, the scooping ends of the upper and lower jaw members are closer together, to preclude animal excrement from passing between their scooping ends. A plastic bag mounted over the upper and lower jaw members forms an excrement receiving pocket open at the scooping ends of the jaw members. To remove the plastic bag, the open end of the plastic bag is pulled off the jaw members, and is pulled via its closed end through a bag passing opening in the upper jaw member.

### FIELD OF THE INVENTION

The present invention relates to an apparatus for picking up and bagging animal excrement, and more particularly to such an apparatus that provides for picking up and bagging animal excrement in a clean and sanitary manner.

### BACKGROUND OF THE INVENTION

It is very common for dog owners to walk their pet dogs for purpose of exercise, and also for letting the dog “do its business”. For sanitary reasons, most dog owners pick up after their dog has had a movement. Such cleaning up after pets is now legislated in many jurisdictions.

Many dog owners simply use a small plastic bag to grab the excrement in and merely turn the bag inside out and tie it closed at the opened end. This is a somewhat undesirable experience, and also provides the possibility of unfortunately touching the excrement with one's fingers. Various prior art devices exist for helping a person pick up dog excrement and store it in a small plastic bag.

U.S. Pat. No. 6,305,322 issued Oct. 23, 2001 to Patel discloses a Pickup Device for Animal Waste. This pickup device comprises a tubular exterior pole with a hollow tube-shaped receptacle attached thereto. A manipulator rod has a handle mounted on one end and a scooper claw mounted on the other end. The scooper claw has four bendable arms. In use, a plastic bag is placed in the scooper claw, and the scooper claw is placed over the animal waste that is to be picked up. The tubular exterior pole and hollow tube-shaped receptacle are moved downwardly and the manipulator rod and scooping claw are moved upwardly, such that the hollow tube-shaped receptacle causes the arms of the scooper claw to close the plastic bag around the animal waste.

U.S. Pat. No. 4,200,319 issued Apr. 29, 1980 to Cooper, discloses a Snap-closing Container. This container is for picking up, enclosing, transporting, and disposing materials, such as pet waste. The container is tray shaped and comprises two hinged integral face panels disposed in a co-extensive planar position in an opened condition, and in an angular position in a closed condition. In the open position, the two hinged panels form a tray surrounded by side and edge panels. The side panels have triangular webs having an apex at the intersection of the hinge and side panel. The container is actuated from its stable open tray like condition to a stable closed triangular clam shell like configuration by the elastic energy of the two spring steel legs of a gripper. The gripper is actuated when it is pulled by an actuating wire into a hollow wand section.

It is an object of the present invention to provide an apparatus for picking up and bagging animal excrement.

It is another object of the present invention to provide an apparatus for picking up and bagging animal excrement, in a clean and sanitary manner.

It is another object of the present invention to provide an apparatus for picking up and bagging animal excrement, that is convenient to use.

It is another object of the present invention to provide an apparatus for picking up and bagging animal excrement, that is inexpensive to manufacture.

### SUMMARY OF THE INVENTION

In accordance with one aspect of the present invention there is disclosed a novel apparatus for picking up and bagging animal excrement. The apparatus comprises an upper jaw member having a hand-grip end and a scooping end, and a lower jaw member having a hand-grip end and a scooping end. There is a hinge means for connecting together the upper jaw member and the lower jaw member at the hand-grip ends, for movement between an open position whereat the scooping ends of the upper jaw member and the lower jaw member are separated one from the other to permit animal excrement to pass therethrough, and a closed position whereat the scooping ends of the upper jaw member and the lower jaw member are closer one to the other than in the open position, so as to preclude the animal excrement from passing between the scooping ends of the upper jaw member and the lower jaw member. A plastic bag having an open end and a closed end is mountable over the upper jaw member and the lower jaw member so as to form an excrement receiving pocket therebetween. The pocket is open at the scooping ends of the upper jaw member and the lower jaw member when the upper jaw member and the lower jaw member are in their open position. The upper jaw member has a bag passing opening therein to permit the plastic bag to pass therethrough from between the upper jaw member and the lower jaw member, when the plastic bag contains excrement therein. To remove the plastic bag from the upper jaw member and the lower jaw member, the plastic bag is pulled via its closed end through the bag passing opening.

In accordance with another aspect of the present invention there is disclosed a novel apparatus for picking up and bagging animal excrement. The apparatus comprises an upper jaw member having a hand-grip end and a scooping end, and a lower jaw member having a hand-grip end and a scooping end. There is a hinge means for connecting together the upper jaw member and the lower jaw member at the hand-grip ends, for movement between an open position whereat the scooping ends of the upper jaw member and the lower jaw member are separated one from the other to permit animal excrement to pass therethrough, and a closed position whereat the scooping ends of the upper jaw member and the lower jaw member are closer one to the other than in the open position, so as to preclude the animal excrement from passing between the scooping ends of the upper jaw member and the lower jaw member. A plastic bag having an open end and a closed end, is mountable over the upper jaw member and the lower jaw member so as to form an excrement receiving pocket therebetween, the pocket open at the scooping ends of the upper jaw member and the lower jaw member when the upper jaw member and the lower jaw member are in their open position. A bag-shaped pouch has an open end and a closed end, and is made from a pliable fabric material. The bag-shaped pouch is attached adjacent its closed end to the upper jaw member and the lower jaw member adjacent the hand-grip ends, such that the bag-shaped pouch can overlie the upper jaw member and the lower jaw member and can be turned inside-out such that the open end of the bag-shaped pouch faces away from the upper jaw member and the lower jaw member.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the apparatus for picking up and bagging animal excrement according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of the preferred embodiment of the apparatus for picking up and bagging animal excrement according to the present invention;

FIG. 2 is a side elevational view of the preferred embodiment apparatus of FIG. 1, in a closed configuration and without the bag-shaped pouch attached;

FIG. 3 is a top plan view of the preferred embodiment apparatus of FIG. 2;

FIG. 4 is a bottom plan view of the preferred embodiment apparatus of FIG. 2;

FIG. 5 is a top plan view of the bag-shaped pouch of the apparatus of FIG. 1;

FIG. 6 is a side elevational view of the preferred embodiment apparatus of FIG. 1, in use, with the jaws in an open configuration;

FIG. 7 is a side elevational view similar to FIG. 6, with a plastic bag in place on the jaws, ready to receive excrement therein;

FIG. 8 is a side elevational view similar to FIG. 7, with the plastic bag having received excrement therein;

FIG. 9 is a side elevational view similar to FIG. 8, with the plastic bag being pulled via its closed end through the bag passing opening in the upper jaw; and,

FIG. 10 is a side elevational view similar to FIG. 9, with the plastic bag having been pulled fully through the bag passing opening in the upper jaw.

FIG. 11 is a side elevational view of the preferred embodiment apparatus of FIG. 1, with the bag-shaped pouch overlying the jaw members, when the apparatus is not in use.

### DETAILED DESCRIPTION OF A PREFERRED EMBODIMENT

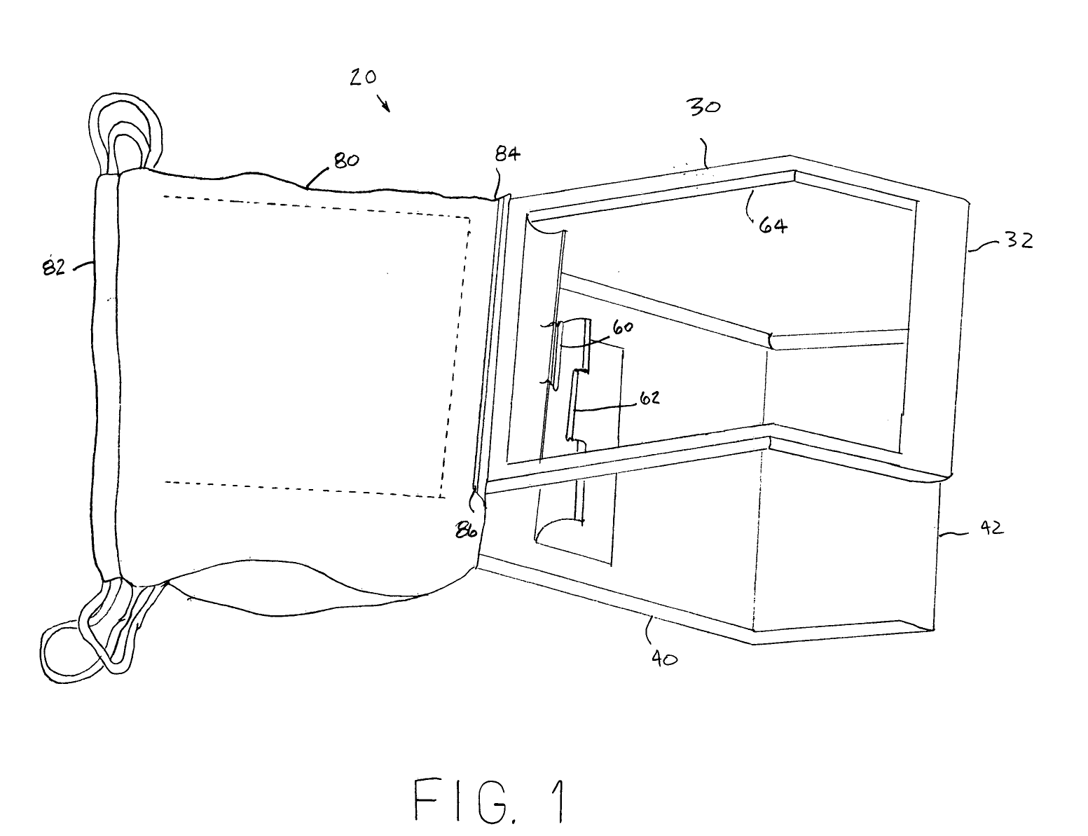

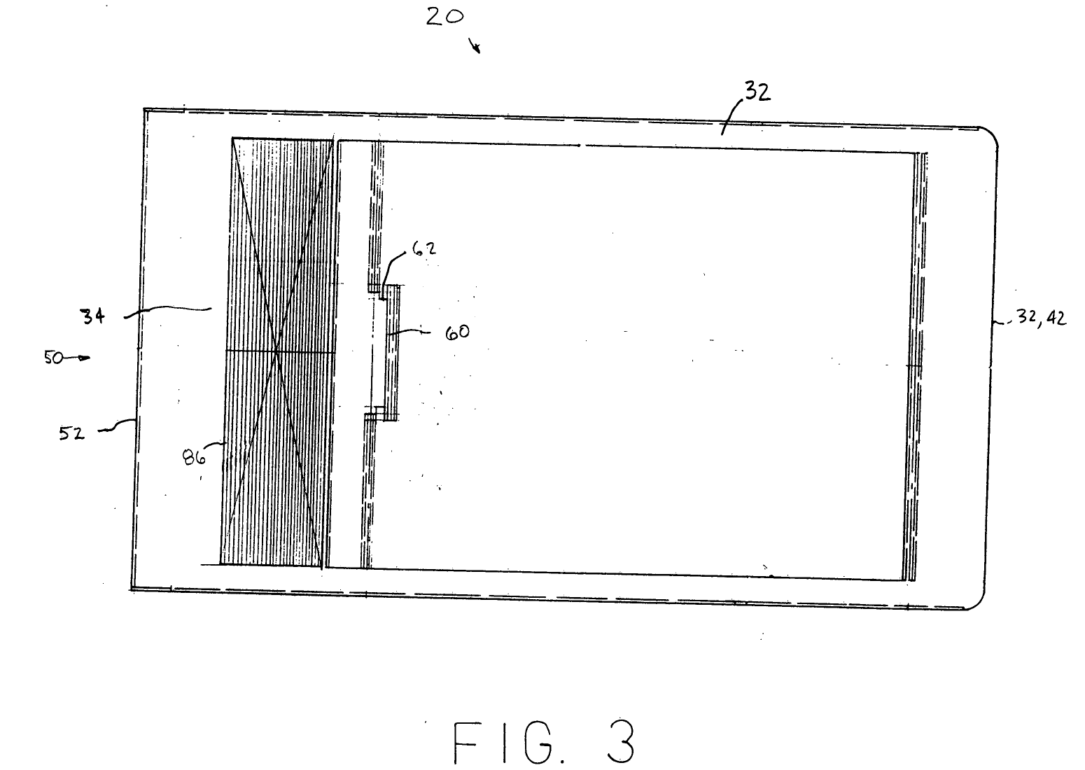

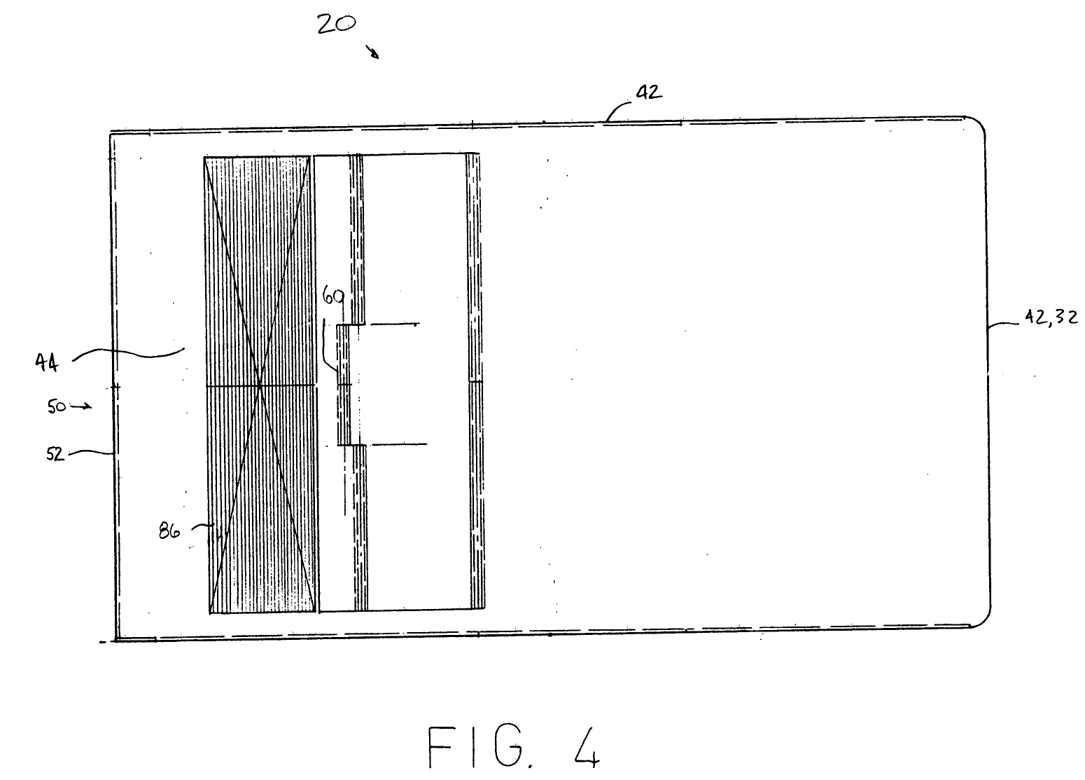

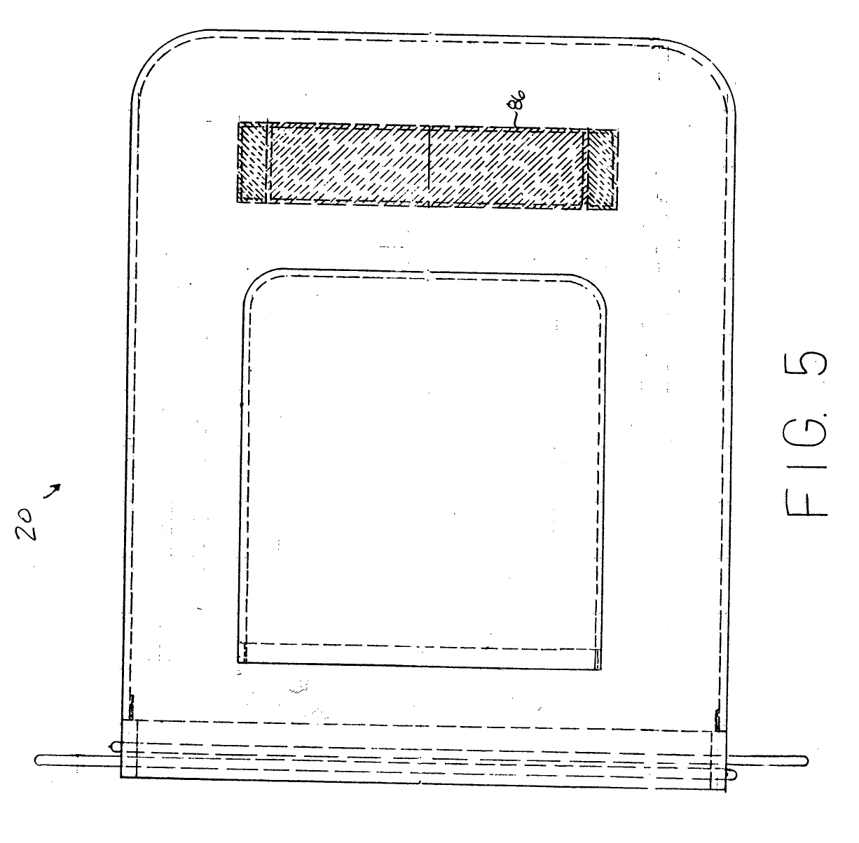

Reference will now be made to FIGS. 1 through 11, which show a first preferred embodiment of the apparatus for picking up and bagging animal excrement of the present invention, as indicated by general reference numeral 20. The apparatus 20 comprises an upper jaw member 30 having a hand-grip end 32 and a scooping end 34, and a lower jaw member 40 having a hand-grip end 42 and a scooping end 44. The upper jaw member 30 and the lower jaw member 40 are each bent about one-third of their length from their respective scooping ends 34,44 such that their respective scooping ends 34,44 are angled towards each other. This bent shape of the upper jaw member 30 and the lower jaw member 40 causes a hollow interior 38 to be formed between the upper jaw member 30 and the lower jaw member 40.

There is a hinge means, as indicated by general reference numeral 50, for connecting together the upper jaw member 30 and the lower jaw member 40 at the hand-grip ends. In the preferred embodiment, as illustrated, the hinge means 50 comprises a flexible hinge 52. Preferably, the upper jaw member 30, the lower jaw member 40, and the flexible hinge 52 are each made from thin metal sheet, with the flexible hinge 52 being welded to the upper jaw member 30 and the lower jaw member 40.

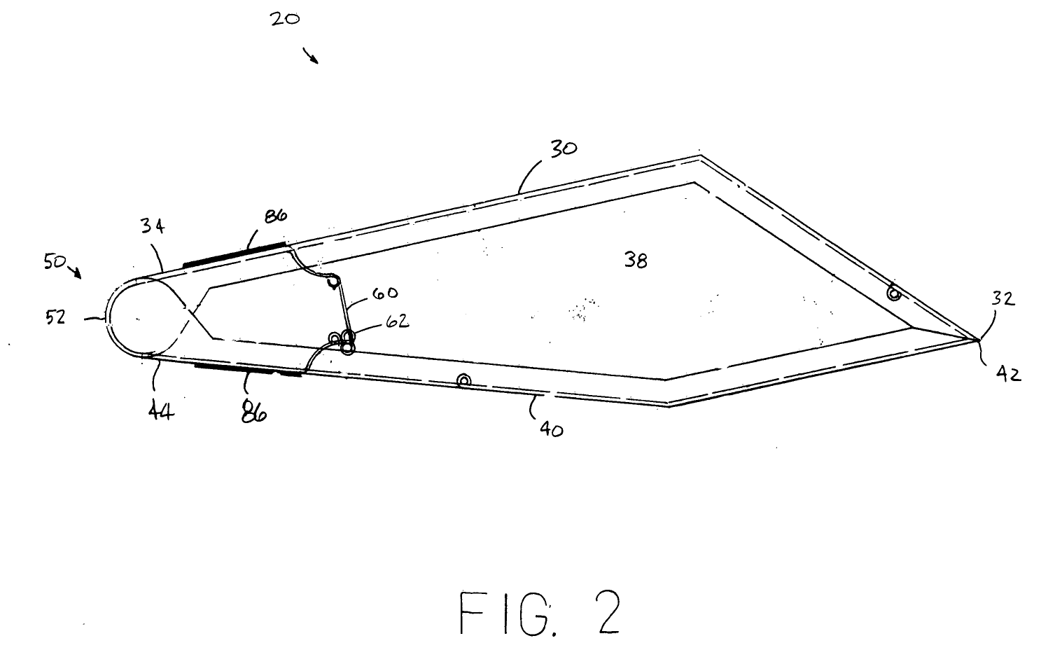

The flexible hinge 52 connects together the upper jaw member 30 and the lower jaw member 40 for movement between an open position, as can be best seen in FIGS. 1 and 6 through 10, and a closed position, as can be best seen in FIGS. 2 through 5. In the open position, the scooping ends 34,44 of the upper jaw member 30 and the lower jaw member 40 are separated one from the other to permit animal excrement 76 to pass therethrough. In the closed position, the scooping ends 34,44 of the upper jaw member 30 and the lower jaw member 40 are closer one to the other than in the open position, and preferably abut one against the other. In this manner, animal excrement 76 is precluded from passing between the scooping ends 34,44 of the upper jaw member 30 and the lower jaw member 40, as will be discussed in greater detail subsequently.

There is also a locking tongue 60 disposed on one of the upper jaw member 30 and the lower jaw member 40. In the preferred embodiment, as illustrated, the locking tongue 60 is disposed on the upper jaw member 30, and projects towards the lower jaw member 40. There is a tongue-receiving notch 62 on the other one of the upper jaw member 30 and the lower jaw member 40. In the preferred embodiment, as illustrated, the tongue-receiving notch 62 is, of course, on the lower jaw member 40. When the locking tongue 60 is engaged in the tongue-receiving notch 62, the of the upper jaw member 30 and the lower jaw member 40 are retained in their closed position. The locking tongue 60 can be readily accessed through an large aperture 64 in the lower jaw member 40. In this manner, the locking tongue 60 can be readily released from the tongue-receiving notch 62, so as to permit the upper jaw member 30 and the lower jaw member 40 to move to their closed position.

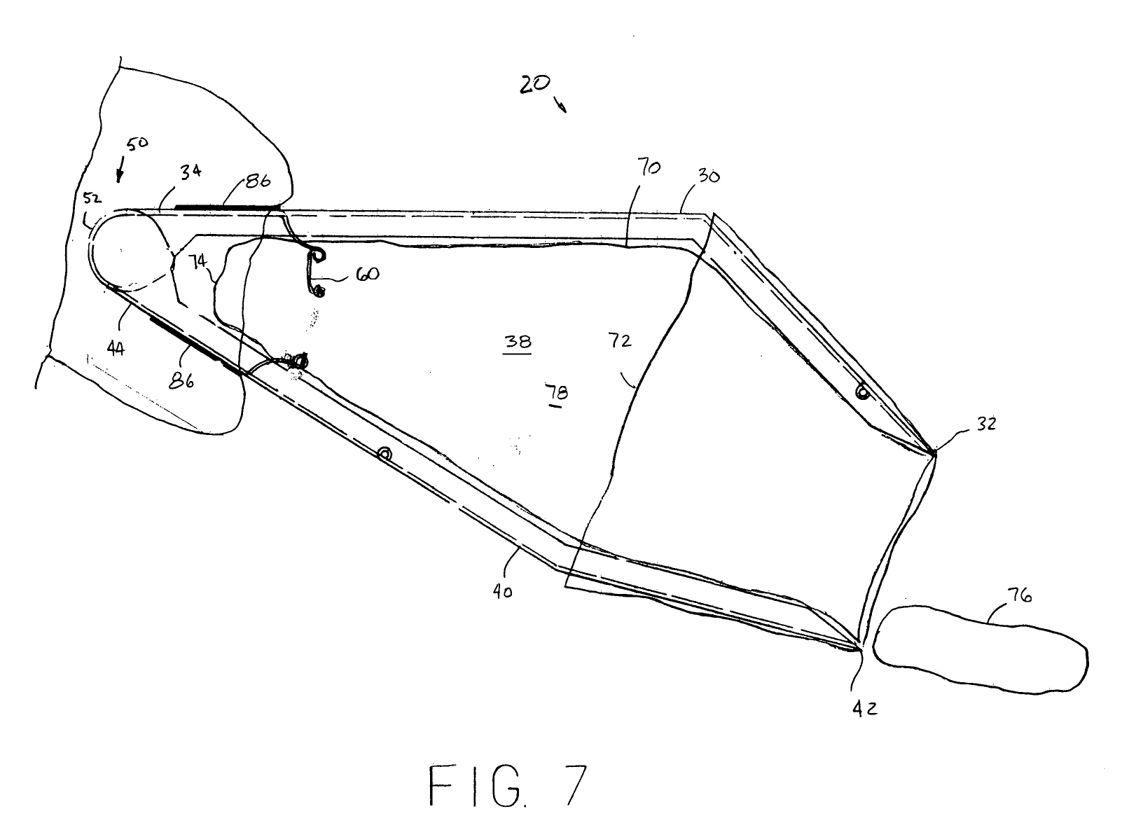

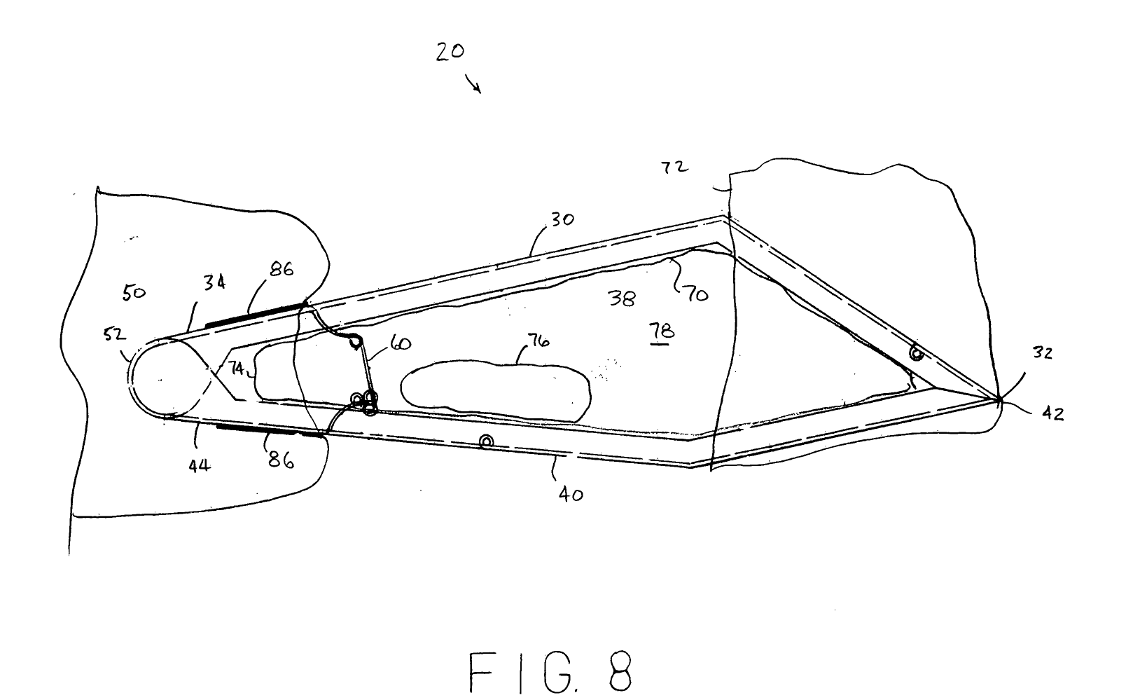

A plastic bag 70 has an open end 72 and a closed end 74. The plastic bag 70 is mountable over the upper jaw member 30 and the lower jaw member 40 so as to form an excrement receiving pocket 78 therebetween, as can be best seen in FIGS. 7 and 8. The pocket is open at the scooping ends 34,44 of the upper jaw member 30 and the lower jaw member 40 when the upper jaw member 30 and the lower jaw member 40 are in their open position, so as to receive animal excrement 76 therein.

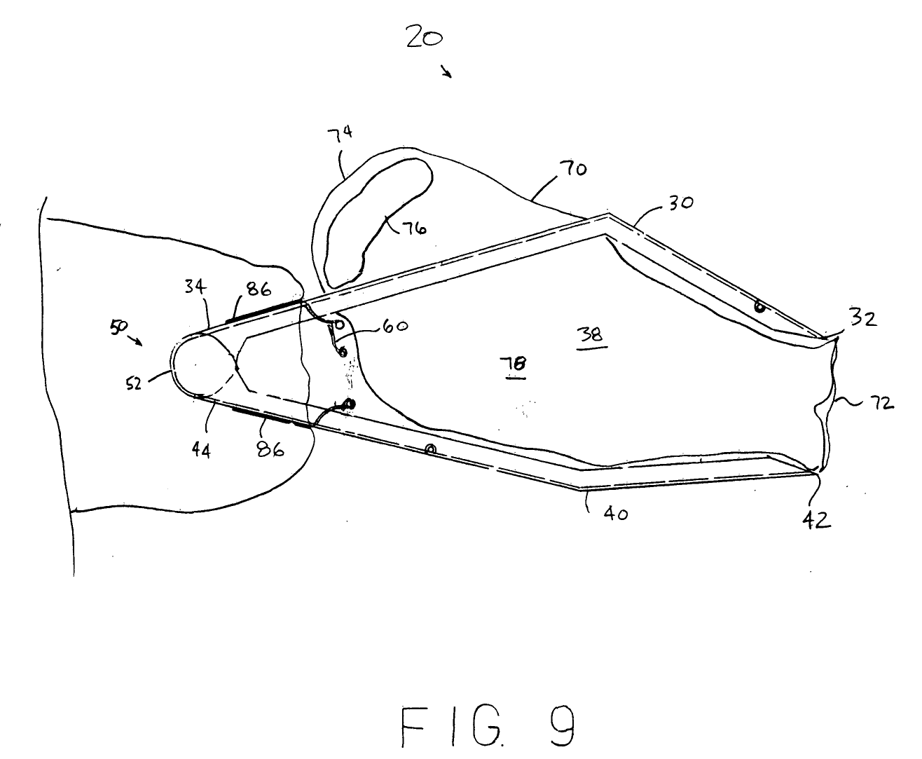

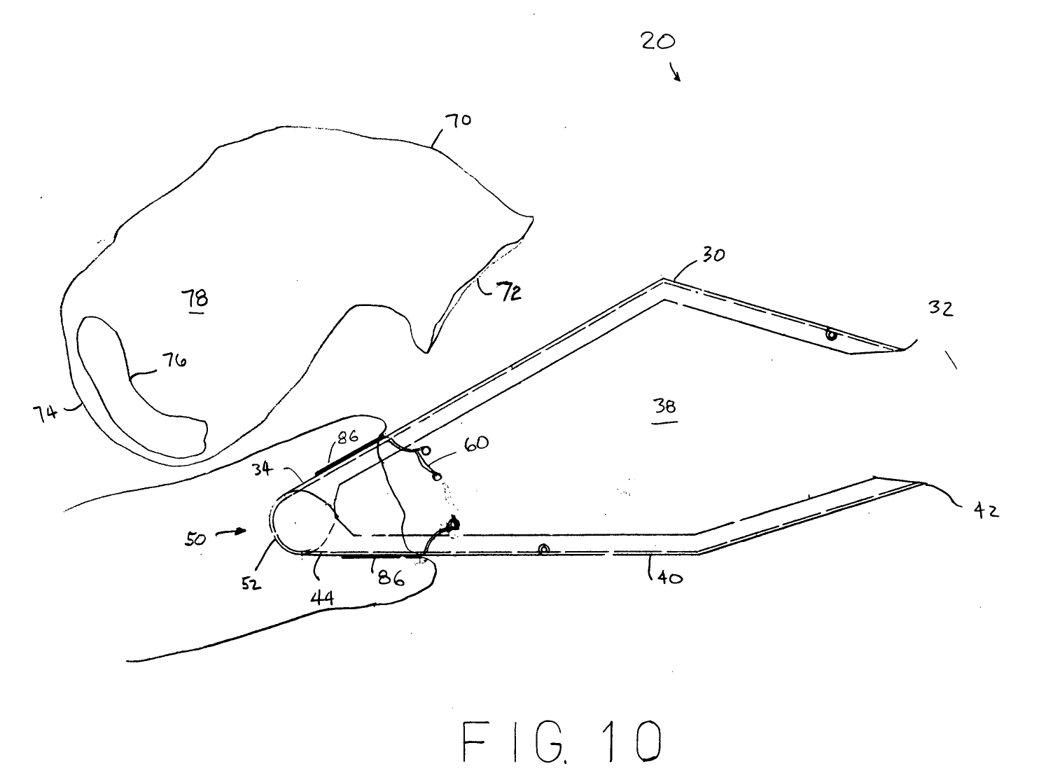

The upper jaw member 30 has a bag passing opening 36 therein to permit the plastic bag 70 to pass therethrough, when the plastic bag 70 is between the upper jaw member 30 and the lower jaw member 40, and when the plastic bag 70 contains excrement 76 therein. In order to remove the plastic bag 70 from the upper jaw member 30 and the lower jaw member 40, the plastic bag 70 having excrement 76 therein is pulled via its closed end 74 through the bag passing opening 36, as can be best seen in FIG. 9. Correspondingly, the open end 72 of the plastic bag 70 is pulled off the upper jaw member 30 and the lower jaw member 40. The plastic bag 70 having excrement 76 therein is pulled through the bag passing opening 36 until it has been pulled fully through the bag passing opening 36, as can be seen in FIG. 10. In this manner, the plastic bag 70 having excrement 76 therein is removed for subsequent disposal, without a person having to touch the open end of the plastic bag 70 where the excrement 76 entered the plastic bag 70.

The apparatus 20 for picking up and bagging animal excrement, further comprises a bag-shaped pouch 80 having an open end 82 and a closed end 84. Preferably the bag-shaped pouch 80 is made from a pliable fabric material, such as Nylon™, or the like. The bag-shaped pouch 80 is attached adjacent its closed end 84 to the upper jaw member 30 and the lower jaw member 40 adjacent the hand-grip ends 32,42. Preferably, the bag-shaped pouch 80 is attached to the upper jaw member 30 and the lower jaw member 40 by pieces of hook and loop fastening material 86, so as to be removable and replaceable.

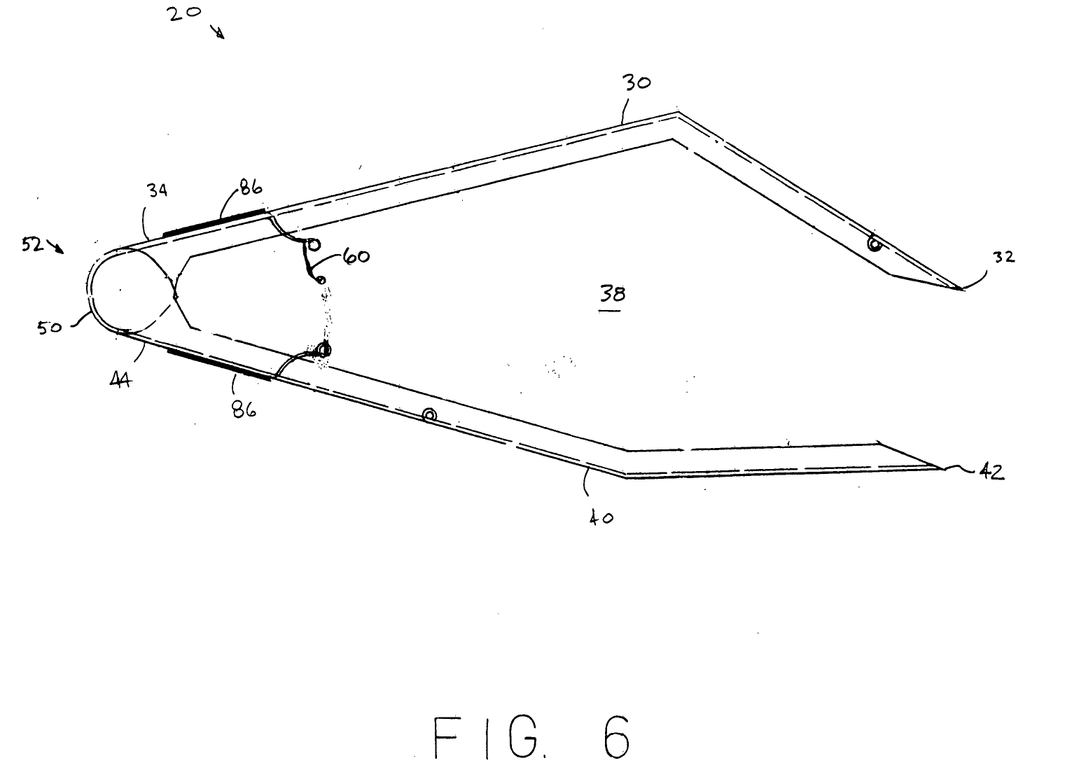

In use, the bag-shaped pouch 80 can be turned inside-out, as can be best seen in FIGS. 6 through 10, such that the open end 82 of the bag-shaped pouch 80 faces away from the upper jaw member 30 and the lower jaw member 40. In this manner, the upper jaw member 30 and the lower jaw member 40 are readily manipulable by a person's hand with the bag-shaped pouch 80, and the person's hand is covered during the act of picking up animal excrement.

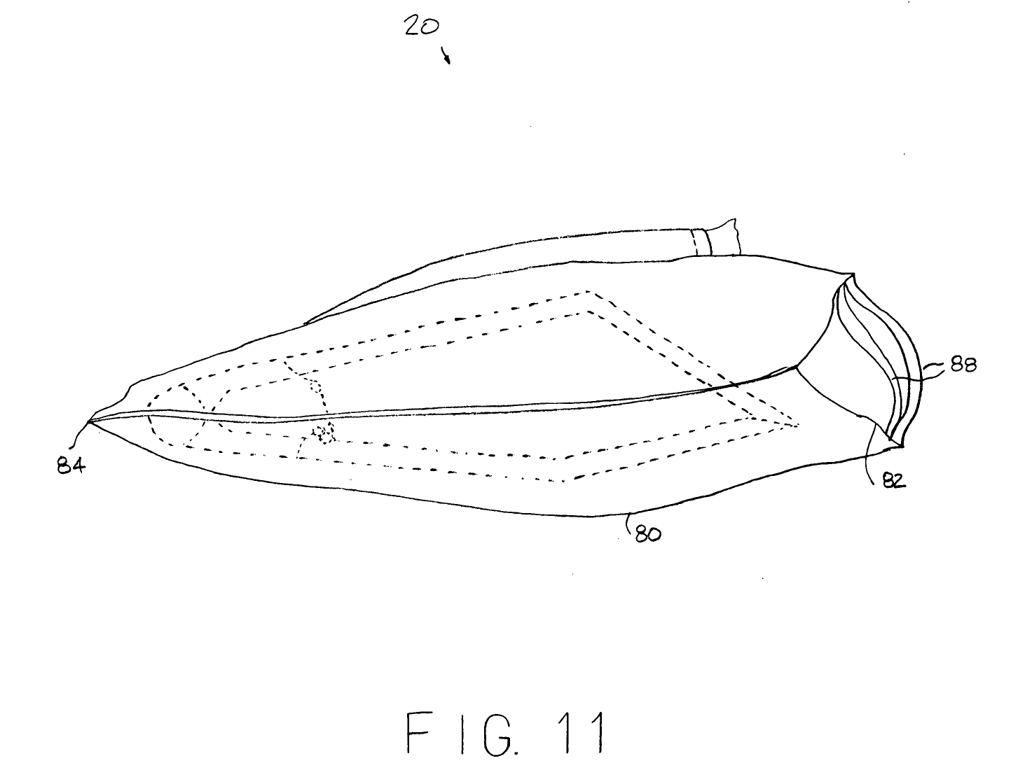

As can be best seen in FIG. 11, the bag-shaped pouch 80 can overlie the upper jaw member 30 and the lower jaw member 40, typically when the apparatus 20 for picking up and bagging animal excrement is not in use. In the preferred embodiment, as illustrated, the bag-shaped pouch 80 has a draw string 88 located at its open end, for keeping the bag-shaped pouch 80 substantially closed around the apparatus 20. A pocket 89 is used to retain plastic bags 70.

As can be understood from the above description and from the accompanying drawings, the present invention provides an apparatus for picking up and bagging animal excrement, in a clean and sanitary manner, that is convenient to use, and that is inexpensive to manufacture, all of which features are unknown in the prior art.

Other variations of the above principles will be apparent to those who are knowledgeable in the field of the invention, and such variations are considered to be within the scope of the present invention. For instance, the flexible hinge could be replaced by a pivoting hinge and a biasing spring. Further, other modifications and alterations may be used in the design and manufacture of the apparatus for picking up and bagging animal excrement of the present invention without departing from the spirit and scope of the accompanying claims.

1. An apparatus for picking up and bagging animal excrement, said apparatus comprising:
an upper jaw member having a hand-grip end and a scooping end;
a lower jaw member having a hand-grip end and a scooping end;
hinge means for connecting together said upper jaw member and said lower jaw member at said hand-grip ends, for movement between an open position whereat said scooping ends of said upper jaw member and said lower jaw member are separated one from the other to permit animal excrement to pass therethrough, and a closed position whereat said scooping ends of said upper jaw member and said lower jaw member are closer one to the other than in said open position, so as to preclude said animal excrement from passing between said scooping ends of said upper jaw member and said lower jaw member; and,
a plastic bag having an open end and a closed end, and being mountable over said upper jaw member and said lower jaw member so as to form an excrement receiving pocket therebetween, said pocket open at said scooping ends of said upper jaw member and said lower jaw member when said upper jaw member and said lower jaw member are in their open position;
wherein said upper jaw member has a bag passing opening therein to permit said plastic bag to pass therethrough from between said upper jaw member and said lower jaw member, when said plastic bag contains excrement therein; and,
wherein, to remove said plastic bag from said upper jaw member and said lower jaw member, said plastic bag is pulled via its closed end through said bag passing opening.

2. The apparatus of claim 1, wherein said hinge means comprises a flexible hinge.

3. The apparatus of claim 2, wherein said upper jaw member, said lower jaw member, and said flexible hinge are each made from thin metal sheet.

4. The apparatus of claim 1, wherein said upper jaw member and said lower jaw member each bent such that their respective scooping ends are angled towards each other.

5. The apparatus of claim 1, further comprising a bag-shaped pouch having an open end and a closed end, and made from a pliable fabric material.

6. The apparatus of claim 1, wherein said bag-shaped pouch is attached adjacent its closed end to said upper jaw member and said lower jaw member adjacent said hand-grip ends, such that said bag-shaped pouch can overlie said upper jaw member and said lower jaw member and can be turned inside-out such that said open end of said bag-shaped pouch faces away from said upper jaw member and said lower jaw member.

7. The apparatus of claim 1, wherein said bag-shaped pouch is attached adjacent its closed end to said upper jaw member and said lower jaw member adjacent said hand-grip ends, as aforesaid, by means of hook and loop fastening material.

8. The apparatus of claim 1, further comprising a locking tongue disposed on one of said upper jaw member and said lower jaw member, and a tongue-receiving notch on the other one of said upper jaw member and said lower jaw member.

9. An apparatus for picking up and bagging animal excrement, said apparatus comprising:
an upper jaw member having a hand-grip end and a scooping end;
a lower jaw member having a hand-grip end and a scooping end;
hinge means for connecting together said upper jaw member and said lower jaw member at said hand-grip ends, for movement between an open position whereat said scooping ends of said upper jaw member and said lower jaw member are separated one from the other to permit animal excrement to pass therethrough, and a closed position whereat said scooping ends of said upper jaw member and said lower jaw member are closer one to the other than in said open position, so as to preclude said animal excrement from passing between said scooping ends of said upper jaw member and said lower jaw member;
a plastic bag having an open end and a closed end, and being mountable over said upper jaw member and said lower jaw member so as to form an excrement receiving pocket therebetween, said pocket open at said scooping ends of said upper jaw member and said lower jaw member when said upper jaw member and said lower jaw member are in their open position; and,
a bag-shaped pouch having an open end and a closed end, and made from a pliable fabric material;
wherein said bag-shaped pouch is attached adjacent its closed end to said upper jaw member and said lower jaw member adjacent said hand-grip ends, such that said bag-shaped pouch can overlie said upper jaw member and said lower jaw member and can be turned inside-out such that said open end of said bag-shaped pouch faces away from said upper jaw member and said lower jaw member.

10. The apparatus of claim 9, wherein said bag-shaped pouch is attached adjacent its closed end to said upper jaw member and said lower jaw member adjacent said hand-grip ends, as aforesaid, by means of hook and loop fastening material.

11. The apparatus of claim 10, wherein said hinge means comprises a flexible hinge.

12. The apparatus of claim 11, wherein said upper jaw member, said lower jaw member, and said flexible hinge are each made from thin metal sheet.

13. The apparatus of claim 9, wherein said upper jaw member and said lower jaw member each bent such that their respective scooping ends are angled towards each other.

14. The apparatus of claim 9, further comprising a locking tongue disposed on one of said upper jaw member and said lower jaw member, and a tongue-receiving notch on the other of said upper jaw member and said lower jaw member.
